(19) United States
(12) Patent Application Publication
(10) Pub. No.: US 2024/0148117 A1
(43) Pub. Date: May 9, 2024

(54) AN ITEM OF JEWELLERY

(71) Applicant: Chee Kheng Tan, SUNGAI PETANI (MY)

(72) Inventor: Chee Kheng Tan, SUNGAI PETANI (MY)

(21) Appl. No.: 18/281,291

(22) PCT Filed: Dec. 23, 2021
(86) PCT No.: PCT/MY21/50125

§ 371 Date: Sep. 9, 2023

(30) Foreign Application Priority Data
Mar. 17, 2021 (MY) PI 2021001426

(51) Int. Cl. A44C 25/00; A44C 15/00; G06K 19/077

(52) U.S. Cl. CPC A44C 25/007; A44C 15/0015; A44C 15/004; G06K 19/07762

(57) ABSTRACT

The present invention discloses an item of jewellery (1) comprising at least one ornament (2), the ornament (2) incorporating means for identification (5) which is visible under a predetermined wavelength of light.

### FIELD OF INVENTION

The present invention relates to an item of jewellery, more particularly, an item of jewellery for containing organic remains as memorabilia.

### BACKGROUND OF THE INVENTION

Nowadays, in order to keep memories animals or loved ones when they were alive, there is nothing specific for the intended purposes, consequently objects of human use end up being adapted in order to keep some of these memories, and when they die, an urn or a flask is used to store their ashes after their cremation. The popularity of cremation is growing within modern society as an alternative to preserving bodies and burying them in coffins. Cremation is also becoming a popular method of dealing with pet remains as cremation is usually less expensive and more ecological than burial. It also offers living individuals and opportunity to keep some of the deceased remains close to them to help facilitate a spiritual connection with the deceased.

Many products have been introduced to the market regarding jewelleries meant as memorabilia. A United States patent with publication no. US20100005835A1 discloses a pearl comprised of cremated remains surrounded by nacre, whereby the cremated remains may be from any person or pet. The pearls containing the cremated remains can be incorporated into fine jewellery to create ageless, beautiful keepsakes for the remembrance of deceased loved ones. Another United States patent with publication no. US20180070686A1 discloses an invention for keeping pets' memories of when they were alive, which corresponds to photos, hairs and nails or after death, in this case the ashes from cremation. The invention comprises of a receptacle or base of circular shape or any other geometric shape, on which fits a lid, with the shape of the foot or paw of a hollow animal which can be used hanging on a chain, on a ring, on bracelets, earrings, key chains, anklets, shrines, and/or other objects of personal use. Yet another United States patent with publication no. US20050081561A1 discloses a method of manufacturing, and resulting pendant for hermetically sealing the crematory remains, hair samples, or the likes of a loved one or pet, utilizing a laser-welding operation to seal congruent front and rear concave housing members together, preserving the contents there within. The metal utilized is thin, therefore each housing member provides a continuous sacrificial lip of metal along the seam to prevent the laser from blowing a hole through the metal housing. A technology as disclosed in a South Korean patent with publication no. KR102114575B1 discloses a memorial pendant with a checking hole to safely store remains and a remains sealing method for the same. The memorial pendant comprises a tube having a through-path penetrated in one direction and including a first bonding groove formed on the outside and a second bonding groove formed on the inside; a first and second cap, wherein the first cap having a ring part for inserting a necklace chain.

The aforementioned prior arts describe the many configurations of apparatus for growing plants, which is one of the key components in the proposed invention. A major drawback arises therefrom as neither of the above-mentioned prior arts provide a method for storing the apparatus, more particularly, the apparatus being wound up in a spiral configuration before being transported away to be kept in storage. The apparatus may later be unwound to be planted in the field and/or farm.

### SUMMARY OF INVENTION

It is an object of the present invention is to provide an item of jewellery, for containing organic remembrances of a loved one or pet there within. It is also an object of the present invention to create an item of jewellery which illuminates in the absence of light, so as to be a centrepiece. Further, it is also an object of the present invention to provide a simple and secure means for identifying remains belonging to a particular pet animal.

It is an aspect of the present invention to provide an item of jewellery comprising of at least one ornament, the ornament incorporating means for identification which is visible under a predetermined wavelength of light.

Preferably, the predetermined wavelength of light is substantially an ultraviolet light wavelength.

Preferably, the ornament comprises of a body for containing organic material.

Preferably, the organic material includes any one or combination of organic remains, hair, coconut husk, and rice grain.

Preferably, the ornament is made out of resin polymer.

Preferably, the ornament further comprises means for illuminating an interior space of the ornament.

Preferably, the means for illuminating the interior space of the ornament include a photoluminescent material incorporated into the resin polymer.

Preferably, the means for identification include any one or combination of a name, a serial number, and a barcode.

Preferably, the item of jewellery further includes a radio-frequency identification (RFID) chip as a secondary means for identification.

Preferably, the radio-frequency identification (RFID) is identified using an external identification reader.

One skilled in the art will readily appreciate that the present invention is well adapted to carry out the objects and obtain the ends and advantages mentioned, as well as those inherent therein. The embodiment described herein is not intended as limitations on the scope of the invention.

### BRIEF DESCRIPTION OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1 illustrates a preferred embodiment of an item of jewellery.

FIG. 2 illustrates a front cross-sectional view of the item of jewellery.

FIG. 3 illustrates a side cross-sectional view of the item of jewellery.

### DETAILED DESCRIPTION OF THE INVENTION

Hereinafter, the invention shall be described according to the preferred embodiments of the present invention and by referring to the accompanying description and drawings. However, it is to be understood that limiting the description to the preferred embodiments of the invention is merely to facilitate discussion of the present invention and it is envisioned that those skilled in the art may devise various modifications without departing from the scope of the appended claim.

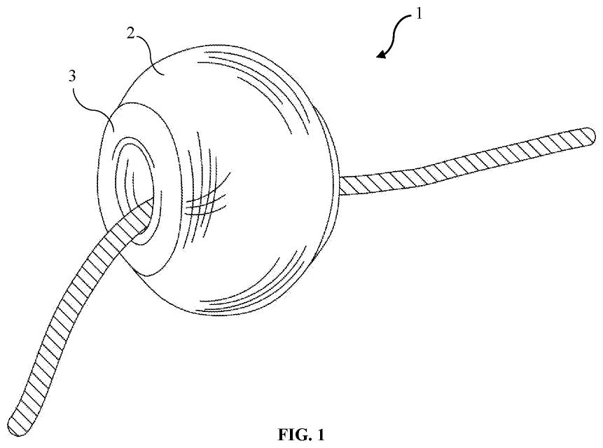

FIGS. 1 to 3 illustrate a preferred embodiment of an item of jewellery 1 comprising of at least one ornament 2, the ornament 2, comprising means for identification 5 which is visible under a predetermined wavelength of light. The ornament 2 in FIG. 1 may have a neck chain or the likes inserted through said ornament 2. The ornament 2 may be of any geometry or shape such as, by way of example but not limited to, a sphere, an oblate spheroid, a cylindrical disk or the likes, depending on a mould in which the ornament 2 is produced in. Preferably, the ornament 2 shape is an oblate spheroid, which is a sphere with a flat surface each on two opposing sides. An aperture may run through a centre of the ornament 2 from one flat surface to the opposing flat surface to allow insertion of the neck chain. Said aperture may also be fitted with any type of metal cores 3, preferably made of stainless steel for prolonging durability of the ornament 2.

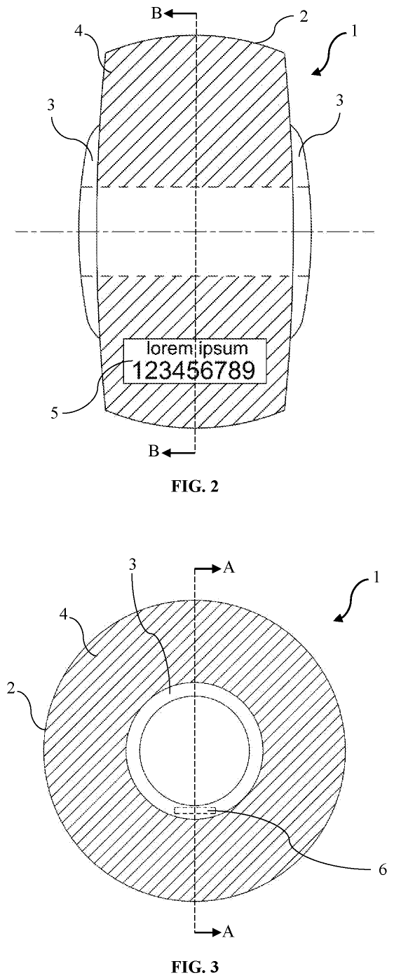

In a preferred embodiment, the ornament 2 comprises a body for containing organic material 4 which includes any one or combination of organic remains, hair, coconut husk and rice grains. Alternatively, other organic materials 4 such as nails or ashes, or inorganic objects such as pictures may be contained within the body of the ornament 2. Preferably, the ornament 2 is made out of resin polymer which is typically transparent or mildly translucent to allow viewing of the organic material 4 within the body of the ornament 2, such as illustrated in hatches in cross sectional views A-A and B-B in FIG. 2 and FIG. 3 respectively. The organic materials 4 may be disposed into the mould prior to filling the mould up with the resin polymer, in which the combination of the organic materials 4 and resin polymer is allowed to cure for a few hours before a finishing process such as polishing or applying a protective coating over the ornament 2.

In a particular embodiment, the ornament 2 further comprises means for illuminating an interior space of said ornament 2. The means of illuminating the interior space of the ornament 2 may be preferably a photoluminescent material incorporated into the resin polymer, in which the photoluminescent material is a material that absorbs and stores particles of light from a light source and on removal or absence of light, the stored particles are released as visible light, causing the material to “glow in the dark”. The photoluminescent material combined with the translucent resin allows the ornament 2 to illuminate at night, making said ornament 2 suitable as a centrepiece in any household. An alternative form of illuminating the interior space of the ornament 2 includes incorporating a light emitting diode (LED) in connection with a battery for powering said LED. However, due to limitations in size for the ornament 2, the LED and battery combination is not preferred in the present invention.

In another preferred embodiment, the means for identification 5 may include any one or combination of a name, a serial number, and a barcode, such as illustrated in FIG. 2. For example, the name, the serial number or the barcode may be imprinted onto the surface of the ornament 2 or onto a piece of paper which may then be incorporated into the ornament 2 with the organic materials 4 and the resin polymer. The name may be of either a pet's name or a pet owner's name. In order to overcome the means for identification 5 being obstructed from view due to the organic materials 4, said means 5, particularly the name or the serial number may be written on or printed with invisible ink, also known as security ink or sympathetic ink, which may be invisible either on application or soon thereafter and can be made visible by illuminating the ink. In this particular embodiment, the invisible ink may be visible when illuminated by light of predetermined wavelength, preferably of a substantially ultraviolet light wavelength which is typically between 100 nm to 400 nm. Besides that, the ornament 2 further includes a radio-frequency identification (RFID) chip 6 which may be in the form of a microchip also incorporated into the ornament 2, whereby the RFID 6 may be disposed in any position along the metal core 3 where it may be hidden from view. Further, the RFID 6 may have, by way of example, belonged to a pet animal which may then be identified using an external identification reader. Said external identification reader may include an RFID reader, a pet microchip reader and the likes.

The present disclosure includes as contained in the appended claims, as well as that of the foregoing description. Although this invention has been described in its preferred form with a degree of particularly, it is understood that the present disclosure of the preferred form has been made only by way of example and that numerous changes in the details of construction and the combination and arrangements of parts may be resorted to without departing from the scope of the invention.

1.-10. (canceled)

11. An item of jewellery, comprising:
at least one ornament, the ornament incorporating means for identification which is visible under a predetermined wavelength of light.

12. The item of jewellery according to claim 11, wherein the predetermined wavelength of light is substantially an ultraviolet light wavelength.

13. The item of jewellery according to claim 11, wherein the ornament comprises a body for containing organic material.

14. The item of jewellery according to claim 13, wherein the organic material includes any one or a combination of organic remains, hair, coconut husk, and rice grain.

15. The item of jewellery according to claim 11, wherein the ornament is made out of resin polymer.

16. The item of jewellery according to claim 15, wherein the ornament further comprises means for illuminating an interior space of the ornament.

17. The item of jewellery according to claim 16, wherein the means for illuminating the interior space of the ornament includes a photoluminescence material incorporated into the resin polymer.

18. The item of jewellery according to claim 11, wherein the means for identification include any one or combination of a name, a serial number, and a barcode.

19. The item of jewellery (1) according to claim 11, further comprising a radio-frequency identification (RFID) chip as a secondary means for identification.

20. The item of jewellery according to claim 19, wherein the radio-frequency identification (RFID) is identified using an external identification reader.
